(19) United States
(12) Patent Application Publication
(10) Pub. No.: US 2012/0132142 A1
(43) Pub. Date: May 31, 2012

(54) SAFETY SYSTEM

(76) Inventor: Hans Holmgren, Stockholm (SE)

(21) Appl. No.: 13/376,110

(22) PCT Filed: May 27, 2010
(86) PCT No.: PCT/EP10/57333

§ 371 Date: Feb. 21, 2012

(30) Foreign Application Priority Data
Jun. 5, 2009 (SE) 0950414-3

(51) Int. Cl. A01J 5/007

(52) U.S. Cl. 119/14.08

(57) ABSTRACT

Methods and systems are disclosed for controlling a milking installation having a movable element that performs a procedure related to extracting milk from milking animals. An exemplary method includes capturing a three-dimensional image of a detected entity present in an operating zone of the movable element, and comparing the captured three-dimensional image to stored image reference data. Based on the comparison, the detected entity is categorized entity as one of a first predefined entity and a second predefined entity. The first predefined entity corresponds to a milking animal and the second predefined entity corresponds to an entity other than a milking animal. Based on the categorization, a control determination is made of whether to allow the movable element to continue the procedure related to milk extraction or to initiate a safety measure. Then, the control determination is implemented.

### THE BACKGROUND OF THE INVENTION AND PRIOR ART

The present invention relates generally to reducing dangers in automatic milking arrangements. More particularly the invention relates to a milking installation according to the preamble of claim 1 and a method according to the preamble of claim 7. The invention also concerns a computer program according to claim 12 and a computer readable medium according to claim 13.

For reasons of efficiency, automatic milking solutions are becoming increasingly sophisticated. The overall degree of automation also increases. Rotary milking parlors represent one type of automated milking that has been known for decades. Here, animals to be milked enter a rotating platform. Milk is then automatically extracted from a given animal while the platform completes one turn. The milking equipment is however attached manually to the animals' teats.

Moreover, automatic milking stations (AMS) have been introduced, which enable animals to autonomously decide when they are to be milked. Automatic milking stations are advantageous because they render it possible to fully automatically service a relatively large number of milking animals via comparatively few milking machines. Automatic milking stations are also desirable from an animal health point-of-view, since thereby it is uncomplicated to extract milk more frequently than by applying the existing alternative solutions, and in general, high-frequency milking vouches for a good udder health.

To further enhance the efficiency, it is desirable to employ one or more robot arms for attaching milking equipment to the animals on a rotary milking parlor. This would maximize the utilization of the milking machine while minimizing the required manual intervention. However, a fully automatic rotary-parlor installation is associated with particular safety and security issues. Since, normally, no human operator will be present when operating the installation, the automatic mechanisms thereof must be stoppable under certain conditions, e.g. in case of an accident, if the apparatus malfunctions or if a person, an animal or an object comes within reach of a moving part. On the other hand, a complete stop may not always be necessary, and excessive stopping of the installation reduces both the efficiency and the animal comfort. Naturally, similar problems exist in connection with other movable elements in milking installations, for instance at a milking robot as such and at so-called crowd gates for driving animals in desired directions in a milking plant.

Traditionally, it has been complicated to establish relevant spatial properties of a dairy animal's teats such that teat cups can be attached thereto automatically. Either bulky or expensive stereo cameras were used, or setups with camera and scanning lasers had to be used. Lately, however, the introduction of so-called time-of-flight (TOF) cameras has simplified this task dramatically.

U.S. Pat. No. 7,490,576 describes a teat location system for an automated milking system, where a TOF camera is used for determining the respective locations and attitudes of an animal's teats in three dimensions.

The published international patent application WO 2008/030086 discloses an implement for automatically milking a dairy animal. Also here TOF technology is used to calculate spatial distances to points on the animal that are relevant for attaching teat cups to the animal's teats. Furthermore, the document suggests that prior to initiating cleaning of a milking parlor images from a 3D camera be used as a basis for determining whether the parlor is completely free of animals, human beings, or objects that hinder cleaning of the parlor.

However, the above-mentioned safety problems concerning automatic milking installations remain unsolved.

### SUMMARY OF THE INVENTION

The object of the present invention is therefore to alleviate these problems, and thus offer a safe milking solution which is also highly efficient.

According to one aspect of the invention, this object is achieved by the initially described milking installation, wherein the control unit is configured to discriminate between at least two different types of separate entities in the image data. In response to detecting a first type of separate entity in the operating zone, the control unit is configured to cause execution of a first action. In response to detecting a second type of separate entity in the operating zone, the control unit is further configured to cause execution of a second action.

This installation is advantageous because it enables adaptation of the milking installation's behavior depending which movable part's safety area that has been intruded and/or which entity that has entered such an area. Consequently, a high degree of efficiency can be combined with a high safety level.

According to one preferred embodiment of this aspect of the invention it is assumed that a milking animal represents the first type of separate entity. Here, the first action involves controlling the at least one movable element to continue an initiated procedure. For example, if a cow is found to be located in a box of a rotary parlor there is no reason to abort the teat cup attachment process. On the contrary, it is appropriate that this process is completed.

According to another preferred embodiment of this aspect of the invention, it is assumed that a human being represents the second type of separate entity. Here, the second action involves generating a warning indication. Thus, if for example the operating zone again includes a box of a rotary parlor, it is adequate to alert the person located here and encourage him/her to leave this area as soon as possible.

According to a further preferred embodiment of this aspect of the invention, the control unit is configured to discontinue the initiated procedure if the second type of separate entity is detected in the operating zone upon expiry of a predetermined interval after generating the warning indication. Continuing to refer to the above example, for safety reasons, no personnel should be within the reach of a milking robot in operation (e.g. inside a box of a rotary parlor). Therefore, it is adequate to stop appropriate movable elements of the installation.

According to yet another preferred embodiment of this aspect of the invention, the control unit is configured to discriminate a third type of separate entity in the image data. The third type of separate entity represents an expendable animal or object, which is deemed not to interfere with the operation of the milking installation. Therefore, the control unit is configured to control the at least one movable element to continue an initiated procedure in response to detecting the third type of separate entity in the operating zone. Hence, if for example a rodent or a small piece of debris enters a milking robot's operating zone this will not influence the continued operation of the robot.

According to still another preferred embodiment of this aspect of the invention, the at least one movable element is represented by a milking robot, a rotary parlor and/or a crowd gate configured to drive milking animals in a desired direction relative to a milking equipment. Consequently, the invention is applicable to many kinds of potential risk zones in a milking installation.

According to another aspect of the invention, the object is achieved by the initially described method, wherein it is discriminated between at least two different types of separate entities in the image data. In response to detecting a first type of separate entity in the operating zone, a first action is caused to be executed, while a second action is caused to be executed in response to detecting a second type of separate entity in the operating zone. The advantages of this method, as well as the preferred embodiments thereof, are apparent from the discussion hereinabove with reference to the proposed milking installation.

According to a further aspect of the invention, the object is achieved by a computer program, which is loadable into the internal memory of a computer, and includes software for controlling the above proposed method when the program is run on a computer.

According to another aspect of the invention, the object is achieved by a computer readable medium, having a program recorded thereon, where the program is to control a computer to perform the above-proposed method.

Further advantages, advantageous features and applications of the present invention will be apparent from the following description and the dependent claims.

### BRIEF DESCRIPTION OF THE DRAWINGS

The invention is now to be explained more closely by means of preferred embodiments, which are disclosed as examples, and with reference to the attached drawings.

FIGS. 1a-b schematically show a milking installation according to one embodiment of the invention;

FIG. 2 illustrates, by means of a flow diagram, the general method according to the invention.

### DESCRIPTION OF PREFERRED EMBODIMENTS OF THE INVENTION

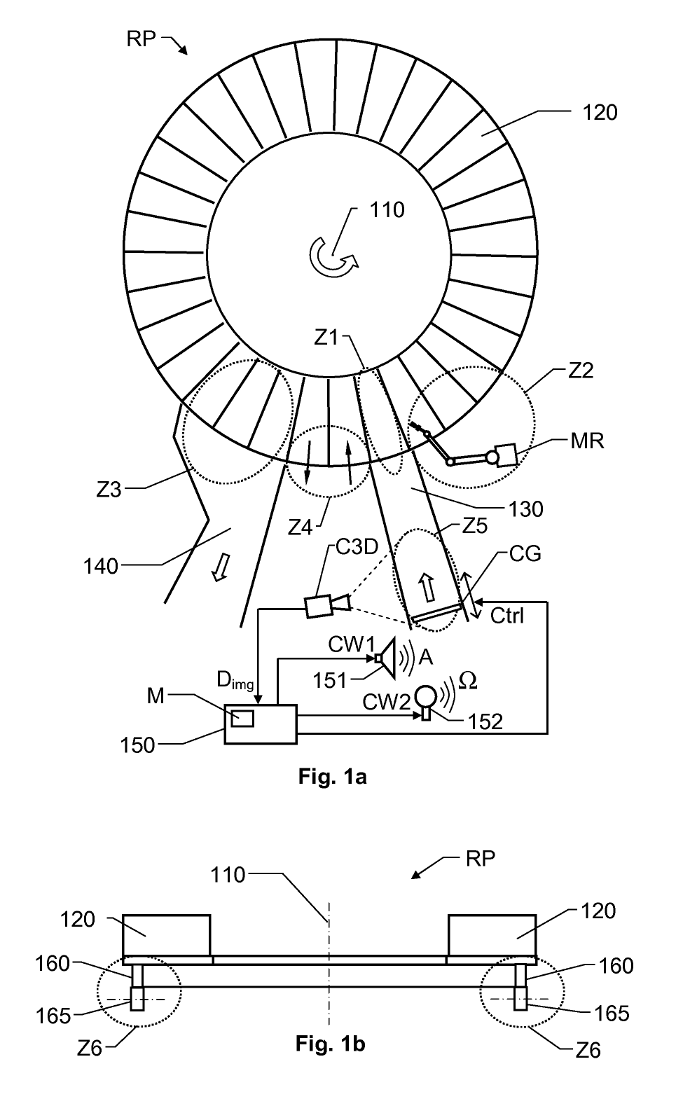

We refer initially to FIGS. 1a and 1b, which schematically show a milking installation according to one embodiment of the invention from a top view and a side view respectively. The milking installation includes at least one movable element, at least one camera C3D and a control unit 150.

Said movable elements may be represented by many different parts, members and components normally being included in an arrangement for milking dairy animals (i.e. cows, buffaloes, goats or sheep), and which are engaged in connection with milk extraction from the animals. Thus, a rotary parlor RP, a milking robot MR and a crowd gate CG may constitute the movable element. Furthermore, one or more parts of for example the rotary parlor RP may be regarded as the movable elements in question. Here, we refer specifically to an entry area (where animals walk into a respective box on the rotary parlor RP), an exit area (where the animals leave the rotary parlor RP after completed milking and having completed essentially one revolution around a rotation axis 110), an area where operators may pass into and out from a central portion of the rotary parlor RP and areas below the rotary parlor RP, where rollers 165 are located which support a track 160 of the platform.

For clarity reasons, FIG. 1a only shows one camera C3D. The camera C3D is configured to register three-dimensional image data D_{img} in real time. Thus; the camera C3D may contain a TOF camera or any other type of camera (e.g. a stereo camera, or an active wavefront sampling camera) capable of producing 3D images in real time. The image data D_{img} represents an operating zone Z5 of a schematically illustrated crowd gate CG configured to drive milking animals in a desired direction relative to milking equipment. Here, the crowd gate CG is specifically adapted to accomplish a desired stream of animals onto the rotary parlor RP.

According to the invention, however, one or more cameras may be configured to register three-dimensional image data D_{img} in real time of other relevant movable elements of the milking installation. Consequently, respective operating zones Z1, Z2, Z3, Z4 and Z6 may likewise be defined at the entry area, around the milking robot, at the exit area, at the area for allowing operators to pass into and out from the central portion of the rotary parlor RP and said areas below the rotary parlor RP.

The control unit 150 controls the operation of the milking installation, and thus inter alia controls the above-mentioned movable elements RP, MR, CG, 160 and 165. The control unit 150 is also configured to receive the image data D_{img}. According to the invention, the control unit 150 is specifically configured to discriminate between at least two different types of separate entities in the image data D_{img}. For example this may be effected based on software capable of extracting certain image properties in the image data D_{img} and relating these properties to various stored references. Since the image data D_{img} contains three-dimensional information it is a comparatively straightforward task to compare the proportions and sizes of various objects with reference data, and thus automatically determine which category an imaged object belongs to. In response to detecting a first type of separate entity in one of the operating zones Z1, Z2, Z3, Z4, Z5 and/or Z6, the control unit 150 is configured to cause execution of a first action; and in response to detecting a second type of separate entity in the operating zone in one of the operating zones Z1, Z2, Z3, Z4, Z5 and/or Z6, the control unit 150 is configured to cause execution of a second action.

A milking animal may represent the first type of separate entity. In such a case, the first type of separate entity is a creature that under normal conditions is expected to be located in the operating zones Z1, Z2, Z3 and Z5. However, the first type of separate entity should under no circumstances be located in either of the operating zones Z4 or Z6. According to one preferred embodiment of the invention, the control unit 150 is configured to cause execution of a first action involving continuing an initiated procedure for the movable element (e.g. rotating the rotary parlor or attaching teat cups) if the first type of separate entity is found to be present in the operating zones Z1, Z2, Z3 and/or Z5. Specifically, if a milking animal is located in the operating zone Z5 proximate to the crowd gate CG this will not influence the issuance of a control signal Ctrl causing the crowd gate CG to open or close.

According to one preferred embodiment of the invention, the second type of separate entity may be represented by a human being. In the embodiment illustrated in FIGS. 1a and 1b, during operation of the installation, only under exceptional circumstances (e.g. when performing service) humans should be expected in the operating zone Z4. In all other operating zones (i.e. Z1, Z2, Z3 Z5 and Z6), the presence of a human being constitutes an anomaly. Therefore, if the control unit 150 detects a second type of separate entity in the form of a human being in one or more of the operating zones Z1, Z2, Z3 Z5 and Z6 (and normally also Z4), the control unit 150 is configured to cause execution of a second action which involves generating a warning indication intended to stimulate the person in question to leave the operating zone. For instance, such a warning indication can be generated as an acoustic signal A (e.g. an alarm sound and/or a playback vocal message) via a loudspeaker member 151 or equivalent; or as an optical signal Ω via a light source 152. Consequently, the control unit 150 may be configured to generate a first control signal CW1 to the loudspeaker member 151 and/or a second control signal CW2 to the light source 152 in response to detecting a human being in one or more of the operating zones Z1, Z2, Z3, (Z4), Z5 and Z6.

If a human being who has invaded an operating zone, e.g. Z5, entirely leaves this area sufficiently quick, there is no need to abort the operation of any movable member, say the crowd gate CG. If, however, this does not happen there is an apparent risk for severe injuries, and even casualties. Therefore, according to one preferred embodiment of the invention, the control unit 150 is configured to discontinue the initiated procedure if the second type of separate entity is detected in one or more of the operating zones Z1, Z2, Z3, Z4, Z5 and/or Z6 upon expiry of a predetermined interval for the zone in question after generating the warning indication, e.g. the above-mentioned acoustic signal A or optical signal Ω.

Technically, under certain conditions (e.g. when servicing the installation), a human being may be the first type of separate entity in respect the operating zone Z4 and a milking animal may be the second type of separate entity.

The areas defined by the operating zones Z6 (i.e. the regions around the rollers 165, which support the track 160 of the rotary parlor's RP platform and a drive unit (not shown)) are potentially extremely dangerous. Any living being (human or animal) located here during operation of the rotary parlor RP risk immediate death by being squeezed between a roller 165 and the track 160. Therefore, if a human being or milking animal is detected here, the control unit 150 is preferably configured to cause the rotary parlor RP to stop instantaneously. One reason for why a person may want to enter the space under the rotary parlor RP is to lubricate the bearings of the rollers 165. Naturally, this should only be done when the rotary parlor RP is stationary.

There are cases when stopping the milking installation, or a part thereof, can be avoided. Namely, some entities are in fact expendable and also small enough not to influence the operation of the milking installation as such even if an animal or object of this type would be present in one or more of the operating zones Z1, Z2, Z3, Z4, Z5 and/or Z6, and as a result be hit/squeezed by a movable member. Rodents and small pieces of debris may constitute examples of such entities. Therefore, according to one preferred embodiment of the invention, the control unit 150 is configured to discriminate a third type of separate entity in the image data D_{img}. The third type of separate entity represents an expendable animal or object, which is deemed not to interfere with the operation of the milking installation. In response to detecting the third type of separate entity in an operating zone Z1, Z2, Z3, Z4, Z5 and/or Z6, the control unit 150 is configured to control the at least one movable element to continue an initiated procedure, e.g. to rotate the rotary parlor RP around its axis 110.

Preferably, the control unit 150 includes, or is associated with, a computer readable medium M, e.g. in the form of a memory module, such that the control unit 150 has access to the contents of this medium M. Furthermore, a program is recorded in the computer readable medium M, and the program is adapted to make a data processor in the control unit 150 control the process described above when the program is run on the processor.

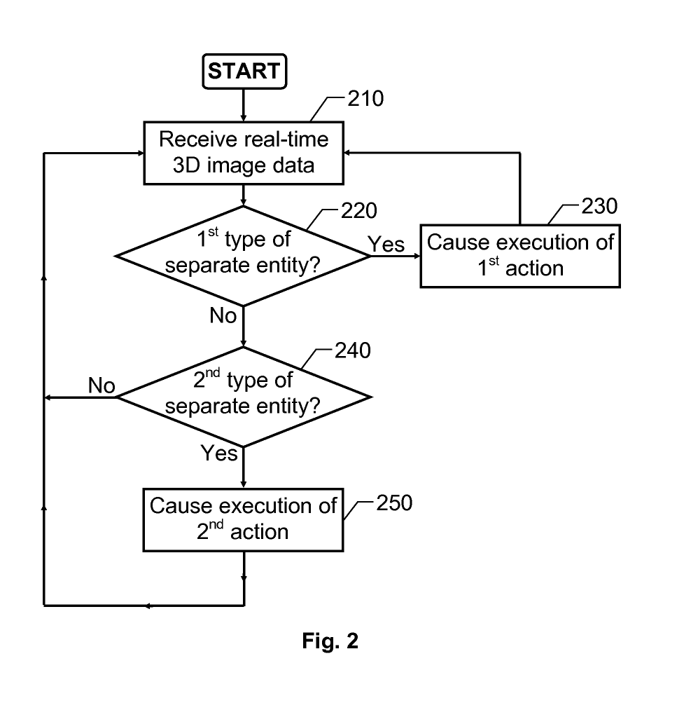

In order to sum up, we will now describe the general method according to the invention with reference to the flow diagram in FIG. 2.

A first step 210 receives three-dimensional real-time image data, i.e. data that may have been recorded by means of a 3D camera. Thereafter, a step 220 checks whether a first type of separate entity is detected in a pre-defined operating zone covered by the image data, and if so, a step 230 follows. Otherwise, the procedure continues to a step 240.

Step 230 causes a first action to be executed. As mentioned above, a milking animal may represent the first type of separate entity, and the operating zone may correspond to the operative range of a milking robot. In such a case, the first action typically involves continuing the operation procedure of the milking robot. After step 230, the procedure loops back to step 210.

Step 240 checks whether a second type of separate entity is detected in the operating zone, and if so, a step 250 follows. Otherwise, the procedure loops back to a step 210. Step 250 causes a second action to be executed. Here, the second type of separate entity may be represented by a human being, and if, again, the operating zone corresponds to the operative range of a milking robot, the second action preferably involves generating a warning message to alert the person in question. After step 250, the procedure loops back to step 210.

All of the process steps, as well as any sub-sequence of steps, described with reference to FIG. 2 above may be controlled by means of a programmed computer apparatus. Moreover, although the embodiments of the invention described above with reference to the drawings comprise computer apparatus and processes performed in computer apparatus, the invention thus also extends to computer programs, particularly computer programs on or in a carrier, adapted for putting the invention into practice. The program may be in the form of source code, object code, a code intermediate source and object code such as in partially compiled form, or in any other form suitable for use in the implementation of the process according to the invention. The program may either be a part of an operating system, or be a separate application. The carrier may be any entity or device capable of carrying the program. For example, the carrier may comprise a storage medium, such as a Flash memory, a ROM (Read Only Memory), for example a DVD (Digital Video/Versatile Disk), a CD (Compact Disc) or a semiconductor ROM, an EPROM (Erasable Programmable Read-Only Memory), an EEPROM (Electrically Erasable Programmable Read-Only Memory), or a magnetic recording medium, for example a floppy disc or hard disc. Further, the carrier may be a transmissible carrier such as an electrical or optical signal which may be conveyed via electrical or optical cable or by radio or by other means. When the program is embodied in a signal which may be conveyed directly by a cable or other device or means, the carrier may be constituted by such cable or device or means. Alternatively, the carrier may be an integrated circuit in which the program is embedded, the integrated circuit being adapted for performing, or for use in the performance of, the relevant processes.

The invention is advantageous because the proposed discrimination between different types of separate entities and the adaptive behavior based on this discrimination renders it possible to operate a milking installation in a safe manner also under conditions when solutions based on previously known technology would have required a complete stop of the installation. For instance, if a rotary parlor is equipped with two or more milking robots, one or more of these robots may be serviced while the remaining robots continue to milk animals. Namely, the system can be adapted to the fact that service personnel is allowed to be present in certain areas, e.g. in proximity to the robot(s) being serviced, and regard other areas as active parts of the installation where no human beings are allowed during operation.

The term “comprises/comprising” when used in this specification is taken to specify the presence of stated features, integers, steps or components. However, the term does not preclude the presence or addition of one or more additional features, integers, steps or components or groups thereof.

The reference to any prior art in this specification is not, and should not be taken as, an acknowledgement or any suggestion that the referenced prior art forms part of the common general knowledge in Australia, or any other country.

The invention is not restricted to the described embodiments in the figures, but may be varied freely within the scope of the claims.

1-13. (canceled)

14. A milking installation for extracting milk from a milking animal, comprising:
a movable element that performs a procedure related to extracting milk from the milking animal;
a storage device storing image reference data, the image reference data reflecting at least a first predefined entity and a second predefined entity;
a camera arranged to capture a three-dimensional image of a detected entity present in an operating zone of the milking installation; and
a milking installation control unit configured to:
extract image properties from the image of the detected entity;
compare the extracted image properties to the stored image reference data;
categorize, based on the comparison, the detected entity as one of the first predefined entity and the second predefined entity, wherein the first predefined entity corresponds to a milking animal and the second predefined entity corresponds to an entity other than a milking animal;
control, if the detected entity is categorized as the first predefined entity, the movable element to continue the procedure related to milk extraction; and
initiate, if the detected entity is categorized as the second predefined entity, a safety measure of the milking installation.

15. The milking installation of claim 14, wherein the safety measure includes at least one of triggering a warning indicator associated with the milking installation or stopping the procedure related to milk extraction.

16. The milking installation of claim 15, wherein the control unit is configured to:
determine whether the detected entity, when categorized as the second predefined entity, remains in the operating zone for a predetermined period of time after triggering the warning indicator; and
control the movable element to stop the procedure related to milk extraction if the detected entity remains in the operating zone for the predetermined period of time.

17. The milking installation of claim 14, wherein the second predefined entity corresponds to a human.

18. The milking installation of claim 17, wherein:
the stored image reference data also reflects a third predefined entity corresponding to a nonhuman object other than the milking animal, and
the control unit is further configured to control, if the detected entity is categorized as the third predefined entity, the movable element to continue the procedure related to milk extraction.

19. The milking installation of claim 14, wherein the movable element is at least one of a robot configured to milk the milking animal, a rotary parlor configured to rotate milking animals through the operating zone, or a crowd gate configured to drive milking animals in a desired direction relative to the operating zone.

20. The milking installation of claim 14, further comprising a plurality of cameras configured to capture three-dimensional images of detected entities present in a respective plurality of operating zones of the milking installation,
wherein the control unit is further configured to:
categorize each of the detected entities in the plurality of operating zones as one of the first predefined entity and the second predefined entity;
control, if the detected entity in each operating zone is categorized as the first predefined entity, the element to continue the procedure related to milk extraction; and
initiate, if the detected entity in any operating zone is characterized as the second predefined entity, the safety measure.

21. A method for controlling a milking installation having a movable element that performs a procedure related to extracting milk from milking animals, the method comprising:
capturing a three-dimensional image of a detected entity present in an operating zone of the movable element; and
comparing, by a control unit, the captured three-dimensional image to stored image reference data reflecting at least a first predefined entity and a second predefined entity;
categorizing, by the control unit and based on the comparison, the detected entity as one of the first predefined entity and the second predefined entity, wherein the first predefined entity corresponds to a milking animal and the second predefined entity corresponds to an entity other than a milking animal;
making a control determination, by the control unit and based on the category of the detected entity, of whether to allow the movable element to continue the procedure related to milk extraction or to initiate a safety measure; and
implementing, by the control unit, the control determination.

22. The method of claim 21, wherein making a control determination includes determining to allow the movable element to continue the procedure related to milk extraction, if the entity is categorized as the first predefined entity.

23. The method of claim 21, wherein making a control determination includes determining to initiate the safety measure, if the entity is categorized as the second predefined entity.

24. The method of claim 21, wherein initiating a safety measure includes at least one of triggering a warning indicator associated with the milking installation or controlling the movable element to stop the procedure related to milk extraction.

25. The method of claim 24, further comprising:
determining whether the detected entity, when categorized as the second predefined entity, remains in the operating zone for a predetermined period of time after triggering the warning indicator; and
controlling the movable element to stop the procedure related to milk extraction if the detected entity remains in the operating zone for the predetermined period of time.

26. The method of claim 21, wherein the second predefined entity corresponds to a human being.

27. The method of claim 26, wherein the stored image reference data also reflects a third predefined entity corresponding to a nonhuman object other than a milking animal, and the method includes:
categorizing the detected entity as one of the first, second, and third predefined entities.
determining, if the detected entity is categorized as the first or third predefined entity, to continue the procedure related to milk extraction; and
determining, if the detected entity is categorized as the second predefined entity, to initiate the safety measure.

28. The method of claim 21, wherein the milking installation includes a plurality of operating zones, each designated for either the first predefined entity or the second predefined entity, and making the control determination includes:
if the operating zone is designated for the first predefined entity and the detected entity is categorized as the first predefined entity, or if the operating zone is designated for the second predefined entity and the detected entity is categorized as the second predefined entity, determining to allow the movable element to continue the procedure related to milk extraction; and
if the operating zone is designated for the first predefined entity and the detected entity is categorized as the second predefined entity, or if the operating zone is designated for the second predefined entity and the detected entity is categorized as the first predefined entity, determining to initiate the safety measure.

29. The method of claim 21, wherein the milking installation includes a plurality of operating zones, and the method further includes:
capturing three-dimensional images of detected entities present the plurality of operating zones;
categorizing each of the detected entities in the plurality of operating zones as one of the first predefined entity and the second predefined entity;
making the control determination based on the category of each of the detected entities in the plurality of operating zones.

30. A computer-readable storage medium storing instructions that, when executed by a computer, causes the computer to perform the method of claim 21.

31. A milking installation for extracting milk from a milking animal, comprising:
a movable element that performs a procedure related to extracting milk from the milking animal;
a storage device storing image reference data, the image reference data reflecting at least a first predefined entity and a second predefined entity;
a camera arranged to capture a three-dimensional image of a detected entity present in an operating zone of the milking installation; and
a milking installation control unit configured to:
compare the captured three-dimensional image to the stored image reference data to categorize the detected entity as one of the first predefined entity and the second predefined entity, wherein the first predefined entity corresponds to a milking animal and the second predefined entity corresponds to an entity other than a milking animal;
make a control determination, based on the category of the detected entity, of whether to allow the movable element to continue the procedure related to milk extraction or to initiate a safety measure; and
implement the control determination.

32. The milking installation of claim 31, wherein the control unit is configured to:
determine to allow the movable element to continue the procedure related to milk extraction, if the entity is categorized as the first predefined entity; and
determine to initiate the safety measure, if the entity is categorized as the second predefined entity.

33. The milking installation of claim 31, wherein:
the second predefined entity corresponds to a human being;
the stored image reference data also reflects a third predefined entity corresponding to a nonhuman object other than a milking animal; and
the control unit is configured to:
categorize the detected entity as one of the first, second, and third predefined entities;
determine, if the detected entity is categorized as the first or third predefined entity, to continue the procedure related to milk extraction; and
determine, if the detected entity is categorized as the second predefined entity, to initiate the safety measure.
